(19) United States
(12) Patent Application Publication
(10) Pub. No.: US 2008/0038640 A1
(43) Pub. Date: Feb. 14, 2008

(54) Alkaline cell with nickel oxyhydroxide cathode and zinc anode

(76) Inventors: Philip D. Trainer, Sandy Hook, CT (US); James A. Rozelle, Fairfield, CT (US)

Correspondence Address: MR. BARRY D. JOSEPHS;ATTORNEY AT LAW, 19 NORTH STREET, SALEM, MA, 01970, US

(21) Appl. No.: 11/501,273

(22) Filed: Aug. 9, 2006

(51) Int. Cl. H01M 4/62; H01M 4/32; H01M 6/04

(52) U.S. Cl. 429/232; 429/223; 429/206

(57) ABSTRACT

A primary alkaline cell has a cathode including a nickel oxyhydroxide and an anode including zinc or zinc alloy particles. Performance of the nickel oxyhydroxide alkaline cell is improved by adding an ionically conductive clay to the cathode.

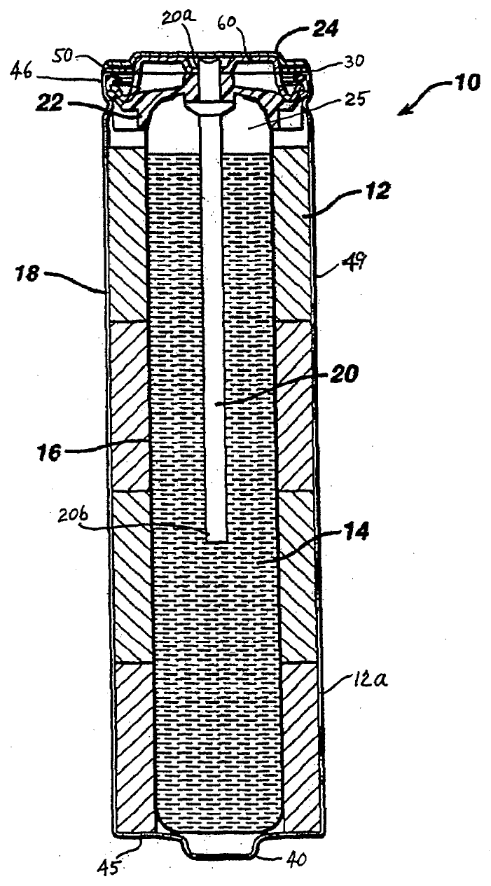

### FIELD OF THE INVENTION

This invention relates to an alkaline cell having a nickel oxyhydroxide cathode and a zinc-based anode, and an ionically conductive clay additive to the cathode.

### BACKGROUND

Conventional alkaline electrochemical cells are primary (non-rechargeable) cells having an anode comprising zinc, a cathode comprising manganese dioxide or nickel oxyhydroxide cathode and mixtures thereof, and an alkaline electrolyte. The cell is formed of a cylindrical housing. The housing is initially formed with an open end. After the cell contents are introduced, an end cap that forms the negative terminal with insulating plug such as plastic grommet is inserted into the open end. The cell is closed by crimping the housing edge over an edge of the insulating plug and radially compressing the casing around the insulating plug to provide a tight seal. The housing serves as the cathode current collector and a portion of the housing forms the positive terminal.

In general, a primary alkaline cell includes an anode, a cathode, an alkaline electrolyte therein, and an electrolyte permeable separator, typically containing a cellulosic or cellophane film between the anode and the cathode. The anode includes an anode active material comprising zinc or zinc alloy particles and conventional gelling agents, such as carboxymethylcellulose or acrylic acid copolymers, and electrolyte. The gelling agent serves to immobilize the zinc particles in a suspension producing a zinc particle network wherein the zinc particles are in contact with one another. An anode current collector, typically a conductive metal nail is inserted into the gelled zinc anode. The alkaline electrolyte is typically an aqueous solution of potassium hydroxide, but can include aqueous solutions of sodium or lithium hydroxide. The cathode includes a cathode active material which may be manganese dioxide or nickel oxyhydroxide or mixtures of both manganese dioxide and nickel oxyhydroxide and an electrically-conductive additive, such as graphite, to increase electrical conductivity of the cathode.

The anode and cathode compositions for alkaline cells are generally electrode specific. That is, except for the alkaline electrolyte which may be present in both anode and cathode compositions, the remaining components of the anode and cathode compositions are generally unique to each of these electrodes. A review of alkaline cell prior art would rarely reveal use of the same component (other than electrolyte) which could effectively be added to both the anode and cathode to result in same or similar beneficial results. For example in the art of zinc/MnO2 alkaline cells an inspection of the general art reveals that most all of the additives reported are electrode specific. For example, mercury has long been known as a benefical additive for zinc anodes to amalgamate the zinc. Indium and bismuth additives to reduce hydrogen gassing as reported in U.S. Pat. No. 5,240,793 are intended to be added to the zinc anode mixture and not to the MnO₂ cathode mixture. Conversely, additives such as specific types of titanium dioxide as reported in U.S. Pat. No. 5,342,712 are intended to be added to the alkaline cell MnO₂ cathode, not the anode, to increase specific capacity. Certain types of graphite, for example, expanded graphite as reported in U.S. Pat. No. 5,482,798, are intended as an additive to alkaline cell MnO₂ cathode and would not be considered as a viable additive to the anode. Similarly other forms of carbon such as acetylene black are intended strictly as additives for alkaline cell cathodes.

LAPONITE clay (available from Rockwood, Inc.) is reported in the manufacturer's brochures to have many commercial applications, primarily as a protective coating additive, varnish and ink additive, adhesive filler, detergent and cleaner additive, and as an additive to personal care products such as toothpastes, nail lacquers, antiperspirants, and shampoos. LAPONITE clay is produced synthetically by combining salts of sodium, magnesium, and lithium with sodium silicate at controlled rates and temperatures. LAPONITE clay has a layered disk-shaped crystalline structure. The manufacturer (Rockwood Inc.) brochures report that the crystals become arranged into stacks which are held together electrostatically by the sharing of sodium ion in the interlayer region between adjacent crystals. When coated onto a substrate the Laponite clay may conduct electricity and thus serve as an antistatic agent.

In U.S. Pat. No. 7,005,213 B2 and International Application WO 02/095850 A1 are reported the beneficial use of LAPONITE clay (Southern Clay Products, now Rockwood Inc.) as an additive to the “anode mixtures” of alkaline cells, in particular the anodes of a zinc/air cell. The zinc/air cell is typically employed in the form of a button cell as a power source for hearing aids. The anode comprises a gelled mixture comprising zinc particles, gelling agent, and alkaline electrolyte. In these references it is reported that the Laponite clay can be added beneficially to the zinc based anodes of such cells. It is reported that the Laponite clay is ionically conductive and that the dispersed clay particles throughout the anode form an ionic network that enhances the transport of hydroxyl ions through the anode matrix. It is reported that this improves performance of a mercury free zinc/air button cell. In U.S. Pat. No. 7,005,213 B2 and WO 02/095850 A1 it is clear that the Laponite clay is intended as an additive to the “zinc based anode” of an alkaline cell, in particular the zinc/air cell. There is no indication in this reference that such clay would be of any benefit as an additive to alkaline cell “cathodes”.

International Application WO 02/13304 A1 discusses the use of a synthetic hectorite and specifically LAPONITE clay for use as a clay gelling agent additive to alkaline cell anodes. Specifically this references discusses the benefit of adding a synthetic hectorite or Laponite clay as gelling gelling agent to the anodes of alkaline cells containing metal particles such as zinc and alkaline electrolyte. The reference discloses that preferably the clay gelling agent is mixed with at least one non clay gelling agent, e.g carboxymethylcellulose (CMC) or crosslinked acrylate polymer (super absorbent polymer). Both the clay and non clay gelling agents, as described in this reference, are intended to be added to the metal anodes, e.g. zinc based anodes of alkaline cells. The clay additive to the alkaline cell anode is said to improve the gelled anode suspension. Specifically, the addition of the clay additive improved the stability of the zinc network in the anodes of zinc/MnO₂ alkaline cells which were tested. The improved anode stability protected the cells better in the event that the cells were dropped or subjected to vibration. There is no mention or contemplation in the reference of adding such clay additive to alkaline cell cathodes.

In U.S. Pat. No. 6,207,322 B1 is disclosed the use of LAPONITE RDS clay available from Southern Clay Products, Inc. (now Rockwood Inc.) as a possible additive to a semisolid putty paste cathode of a zinc/MnO₂ alkaline cell as shown in formulation 1 of the reference. This Laponite clay additive to the putty paste cathode comprising MnO₂ was used to improve the mixing properties of the paste and did not noticeably improve cell performance and percent MnO₂ utilization. (See, U.S. Pat. No. 6,207,322, Table 1)

### SUMMARY OF THE INVENTION

An aspect the invention relates to alkaline cells having an anode comprising zinc and a cathode comprising nickel oxyhydroxide. The cell is desirably in the form of a primary (nonrechargeable) cell. The invention is directed to adding an ionically conductive clay, preferably a synthetic hectorite, such as LAPOINITE clay (available from Rockwood, Inc.) to cathodes of such nickel oxyhydroxide cells.

Clays are composed of very fine particles of clay minerals which are layered aluminum silicates containing structural hydroxyl groups. Crystalline (or paracrystalline) clays which may exhibit ionic conductive properties are kaolins, talc and pyrophyllites, smectites (montmorillonites), hectorites, illites, glauconites, chlorite, vermiculites, and palygorskite and sepiolites. (These clay classes are described in Kirk-Othmer, The Encyclopedia of Chemical Technology, 4^{th} Ed., Vol. 6, pp. 381-405.) It is predicted based on the experiments herein presented employing a synthetic hectorite clay (known as LAPONITE clay from Rockwood, Inc) as a cathode additive to primary alkaline cells comprising nickel oxyhydroxide cathodes, that ionically conductive clays from clays (natural or synthetic) which are selected from kaolins, pyrophyllites, smectites (montmorillonites), hectorites, illites, glauconites, chlorites and vermiculites, and mixtures thereof, could be added beneficially to the nickel oxyhydroxide cathodes of primary nickel oxyhydroxide cells, to improve cell performance. The desired cathode for such cells thus comprises nickel oxyhydroxide cathode active material, conductive carbon (preferably graphite), ionically conductive clay, and alkaline electrolyte, preferably comprising aqueous potassium hydroxide; and a desired anode for such cell comprises zinc particles. The ionically conductive clay is desirably added in amount between about 0.01 and 0.4 wt % to the cathode containing nickel oxyhydroxide.

An aspect of the invention is directed to adding clays from the smectite mineral (montmorillonites) class to cathodes comprising nickel oxyhydroxide in view of the good ionic conductivity properties of clays from this class. A particular clay from the smectite mineral class is known as hectorite as referenced in International Application WO 02/13304 A1. The hectorite is a magnesium silicate in which the anionic silicate lattice may contain lithium and or fluorine atoms and is charge balanced by sodium or other cations. Examples of hectorites include sodium magnesium silicate, sodium magnesium fluorosilicate, sodium lithium magnesium silicate and sodium lithium magnesium fluorosilicate. A synthetic hectorite has a greater purity than natural hectorite, because it can be made from pure materials. As reported in International Application WO 02/13304 A1 synthetic hectorites may have the empirical formula:

[Si₈(MgₐLi_{b}H_{c})O₂₀(OH)_{4-y}F_{y}]zM⁺ (Eq. 1)

wherein a=4.95 to 5.7; b=0 to 1.05; c=0 to 2; a+b+c=4 to 8, y=0 to 4, z=(12−2a−b−c) and M is Na⁺, Li⁺ or another charge balancing cation.

A commercially useful synthetic hectorite is available under the trade designation LAPONITE clay from Rockwood International Inc. (formerly Southern Clay Products, Inc). The LAPONITE clay has the empirical formula:

Na^{+0.7}_{0.70}[(Si₈Mg_{5.5}Li_{0.3})O₂₀(OH)₄]^{-0.7} (Eq. 2)

In a principal aspect of the present invention, it has been determined that the addition of the LAPONITE clay to nickel oxyhydroxide cathodes for use in a zinc/nickel oxyhydroxide primary cell improves the performance of the cell. The LAPONITE clay is desirably added in amount between about 0.01 and 0.4 wt % to the cathode containing nickel oxyhydroxide. A preferred LAPONITE clay additive to the nickel oxyhydroxide cathode is available under the trade designation LAPONITE RD, which is a rapidly dispersing grade, from Rockwood International, Inc. Other grades of Laponite would also be effective.

It is not known for certain why the addition of the LAPONITE clay to the cathode improves the performance of the zinc/nickel oxyhydroxide cell. It may be that one or more of the components in the nickel oxyhydroxide cathode enhances the ionic conductivity of the LAPONITE clay to improve transport of hydroxyl ions through the cathode. The good electrical conductivity of the LAPONITE clay may also play a role in achieving improved performance in conjunction with the use of graphite, in particular oxidation resistant graphite additive, in the context of a nickel oxyhydroxide cathode mixture employing alkaline electrolyte. The net result is distinctively improved performance of the zinc/nickel oxyhydroxide primary cell when LAPONITE clay is added to the cathode. The addition of the LAPONITE clay to the nickel oxyhydroxide cathode also reduces loss of capacity (mAmp-hrs) upon cell storage at elevated temperatures.

It should also prove desirable to add LAPONITE clay to the cathodes of nickel based rechargeable cells such as nickel metal hydride rechargeable cells. These cells also include nickel oxyhydroxide in the cathode, and thus the addition of LAPONITE clay to the cathode of such cells is predicted to result in improved cell performance on discharge.

### BRIEF DESCRIPTION OF THE FIGURE

The FIGURE is a cross-section view of a representative cylindrical alkaline cell of the invention having a cathode comprising nickel oxyhydroxide and an anode comprising zinc-based particles.

### DETAILED DESCRIPTION

Referring to the FIGURE, electrochemical cell 10 includes a cathode 12 (positive electrode) comprising nickel oxyhydroxide, an anode 14 (negative electrode) comprising zinc particles, a separator 16 and a cylindrical housing 18. Cell 10 also includes current collector 20, insulating plug 22, and a negative metal end cap 24, which serves as the negative terminal for the cell. The housing 18 has a cylindrical body 49, an open end 25 and an opposing closed end 45. An end cap assembly 50 is inserted into the open end 25 of housing 18. The peripheral edge 46 of housing 18 is crimped over a portion of end cap assembly 50 thereby closing said open end. The end cap assembly 50 comprises an insulating plug 22, current collector 20, negative end cap 24, and a metal support disk 60 between end cap 24 and insulating plug 22. Current collector 20 is inserted through a central opening in the insulating plug 22 and the top end 20a of the current collector is welded to end cap 60. As end cap assembly 50 is inserted into the housing open end 25, the current collector tip end 20b penetrates into anode 14. The housing peripheral edge 46 is crimped over the edge of metal support disk 60 with the peripheral edge of insulating plug 22 therebetween. The end cap assembly 50 thus becomes firmly secured to the housing with support disk 60 in radial compression. The end cap 24 is insulated from housing 18 by a paper or plastic washer 30. End cap 24 is in electrical contact with anode 14 through anode current collector 20 and thus forms the cell's negative terminal. The cathode 12 is in contact with the housing 18 and a portion of the housing, typically at the bottom closed end thereof, forms the positive terminal 40. Insulating plug 22 is a plastic member preferably containing a rupturable diaphragm or membrane (not shown) integrally formed therein as described, for example, in U.S. Pat. No. 3,617,386. The membrane forms a thin region within insulating plug 22 and is designed to rupture should gas within the cell rise to a high level, for example, above about 100 psig, typically between about 200 and 500 psig.

Cathode 12 has an annular structure with an outer surface in electrical contact with the inner surface of housing 18, which also serves as the cathode current collector and the positive external cell terminal. Cathode 12 includes a nickel oxyhydroxide active cathode material, an ionically conductive clay additive, conductive carbon particles, and electrolyte solution. Cathode 12 may also include a binder material. Cathode 12 can be formed by stacking multiple smaller slabs, disks, pellets or rings 12a which can be die cast or compression molded. Alternatively, cathode 12 can be formed by extrusion through a nozzle to form a single continuous cathode 12 having a hollow core. Cathode 12 can also be formed of a plurality of rings 12a with hollow core, wherein each ring is extruded into housing 18.

An electrolyte solution becomes dispersed throughout cell 10 contacting the anode and cathode. Cell 10 can be, for example, an AA, AAA, AAAA, C or D size cylindrical cell. Alternatively, cell 10 can be a prismatic, laminar or thin cell, or a coin or button cell.

It has been determined that the addition of a synthetic hectorite, namely LAPONITE clay (available from Rockwood, Inc.) to cathodes comprising nickel oxyhydroxide in a zinc/nickel oxyhydroxide alkaline cell improves the performance of the cell. The LAPONITE clay may be added in amount between about 0.01 and 0.4 wt % to the cathode containing nickel oxyhydroxide, preferably between about 0.01 and 0.04 wt % to said cathode containing nickel oxyhydroxide. A preferred LAPONITE clay additive to the nickel oxyhydroxide cathode is available under the trade designation LAPONITE RD, which is a rapidly dispersing grade, from Rockwood International, Inc. (LAPONITE RD clay has a BET surface area of about 300 m²/g).

The synthetic hectorites, in particular, LAPONITE clay, have elevated ionic conductivity properties, which is believed to play a principal role in improving ionic transport, including hydroxyl ion transport, within the nickel oxyhydroxide cathode matrix. The presence of nickel ions and graphite in the cathode may have synergistic effect on the ionically conductive clay to further enhance the ionic and electrical conductivity through the cathode. The net result is an improvement in performance of the nickel oxyhydroxide primary cell when the ionically conductive clay is added to the cathode in small amounts, e.g. between about 0.01 and 0.4 wt %, desirably between about 0.01 and 0.04 wt %, for example, between about 0.01 and 0.03 wt % of the cathode. Although the synthetic hectorite, such as LAPONITE clay, is preferred, it is believed that other clays, from other clay classes which are ionically conductive such as kaolins, pyrophyllites, smectites (montmorillonites), hectorites, illites, glauconites, chlorite and vermiculites, and palygorskite and sepiolites can be a desirable additive to the nickel oxyhydroxide cathode.

Anode 14 can be formed of any of the zinc-based materials conventionally used in zinc battery anodes. For example, anode 14 can be a zinc slurry that can include zinc or zinc alloy particles, a gelling agent, and minor amounts of additives, such as a gassing inhibitor. In addition, a portion of the electrolyte solution can be dispersed throughout the anode. The zinc-based particles can be any of the zinc-based particles conventionally used in zinc slurry anodes. The anode can include, for example, between 60 wt. % and 80 wt. %, between 63 wt. % and 75 wt. %, or between 67 wt. % and 71 wt. % of zinc-based particles. The zinc-based particles can be small size zinc-based particles, such as zinc fines or zinc dust. A zinc-based particle can be formed of, for example, zinc or a zinc alloy. Preferred zinc-based particles are essentially both mercury-free and lead-free. Metals that can be alloyed with zinc to provide zinc-based particles preferably include those that can inhibit gassing, such as indium, bismuth, aluminum, and mixtures thereof. As used herein, gassing refers to the evolution of hydrogen gas resulting from a reaction of zinc metal with the electrolyte. The presence of hydrogen gas inside a sealed battery is undesirable because a pressure buildup can cause leakage of electrolyte. Generally, a zinc-based particle formed of a zinc alloy is greater than 95 wt. % zinc, typically greater than 99.9 wt. % zinc. The term zinc or zinc powder as used herein shall be understood to include zinc alloy powder which comprises a high concentration of zinc and as such functions electrochemically essentially as pure zinc.

Anode 14 preferably includes zinc fines which are mixed with zinc-based particles having a larger average particle size. One convenient measure of the amount of zinc fines in the total zinc particles is the percentage by weight of the total zinc particles which pass through a sieve of 200 mesh size. Thus, as used herein “zinc fines” are zinc-based particles small enough to pass through a 200 mesh sieve. The reference 200 mesh size is a Tyler standard mesh size commonly used in the industry and corresponds to a U.S. Standard sieve having a square 0.075 mm opening. (Tables are available to convert a specific Tyler mesh sizes to square openings in millimeters as reported in the U.S.A. Standard Taylor Screen Specification ASTME-11 specification.)

The anode 14 preferably comprises zinc fines which can be admixed with zinc-based particles of larger average particle size. The anode desirably includes at least 10 wt %, at least 15 wt %, at least 30 wt %, or at least 80 wt %, typically between 35 and 75 wt % of the total zinc or zinc alloy particles small enough to pass through a −200 mesh screen. Such zinc fines typically can have a mean average particle size between about 1 and 75 microns, for example, about 75 microns. Inclusion of zinc fines in anode 14 of a zinc/nickel oxyhydroxide cell has been demonstrated to improve performance as reported in commonly assigned U.S. Pat. No. 6,991,875.

Anode 14 typically can have total mercury content less than about 100 parts per million parts (ppm) of zinc by weight, preferably less than 50 parts mercury per million parts of zinc by weight. Also, the anode preferably does not contain any added amounts of lead and thus is essentially lead-free, that is, the total lead content is less than 30 ppm, desirably less than 15 ppm of the total zinc in the anode. The anode typically can include aqueous KOH electrolyte solution, a gelling agent (e.g., a crosslinked acrylic acid copolymer available under the tradename CARBOPOL C940 from B.F. Goodrich), and surfactants (e.g., organic phosphate ester-based surfactants available under the tradename GAFAC RA600 from Rhône Poulenc). (Other conventional gelling agents, such as sodium carboxymethyl cellulose or the sodium salt of an acrylic acid copolymer may also be used.) Such an anode composition is presented only as an illustrative example and is not intended to restrict the present invention.

Cathode 12 can include nickel oxyhydroxide (NiOOH) as the active cathode material, conductive carbon particles, including graphite, and alkaline electrolyte solution. Optionally, the cathode also can include an oxidizing additive, a binder, or combinations thereof. Generally, the cathode can include, for example, between 60 wt. % and 97 wt. %, between 80 wt. % and 95 wt. %, or between 85 wt. % and 90 wt. % of nickel oxyhydroxide. Optionally, cathode 12 can include an admixture of two or more active cathode materials, for example, a mixture of nickel oxyhydroxide and gamma-manganese dioxide (i.e., electrolytically produced manganese dioxide or chemically produced manganese dioxide) as disclosed for example, in U.S. Pat. No. 6,566,009.

The basic electrochemical discharge reaction at the cathode can involve reduction of nickel oxyhydroxide according to the following principal representative reaction, though secondary reactions are possible as well:

NiOOH+H₂O+1e⁻→Ni(OH)₂+OH⁻ (Eq. 3)

A suitable nickel hydroxide can consist of particles that are approximately spherical in shape (i.e., the outer surfaces of the particles-approximate spheres, spheroids or ellipsoids). The nickel hydroxide can include a beta-nickel hydroxide, a cobalt hydroxide-coated beta-nickel hydroxide, an alpha-nickel hydroxide, a cobalt hydroxide-coated alpha-nickel hydroxide and mixtures thereof. Preferably, the nickel oxyhydroxide includes essentially non-fractured spherical particles. The nickel oxyhydroxide can have mean average particle sizes ranging from, for example, 2 to 50 microns, 5 to 30 microns, 10 to 25 microns or 15 to 20 microns. Suitable commercial beta-nickel oxyhydroxides and cobalt oxyhydroxide-coated beta-nickel oxyhydroxides can be obtained for example, from the Kansai Catalyst Co. (Osaka, Japan), Tanaka Chemical Co. (Fukui, Japan), H.C. Starck GmbH & Co. (Goslar, Germany), or Umicore-Canada Inc., (Sherwood Park, Alberta).

Cathode 12 can include an optional binder. Examples of suitable binders include polymers such as polyethylene, polypropylene, polyacrylamide, or a fluorocarbon resin, for example, polyvinylidene difluoride or polytetrafluoroethylene. A suitable polyethylene binder is sold under the trade name COATHYLENE HA-1681 (available from Hoechst). The cathode can include, for example, between 0.05% and 5% by weight or between 0.1% and 2% by weight of binder. A portion of the electrolyte solution can be dispersed throughout cathode 12, and the weight percentages provided above and below are determined after the electrolyte solution has been so dispersed.

Cathode 12 can include conductive carbon particles, which can be present in an admixture with nickel oxyhydroxide to improve bulk electrical conductivity of the cathode. More particularly, the cathode can include between 2 wt. % and 12 wt. % or between 4 wt. % and 10 wt. % or between 6 wt. % and 8 wt. % of conductive carbon particles. Conductive carbon particles can include graphitized carbon, carbon black, petroleum coke or acetylene black. Preferred conductive carbon particles are highly graphitized. Graphitized carbon can include natural graphite, synthetic graphite, expanded graphite, graphitized carbon black or a mixture thereof. The natural or synthetic graphite can be an oxidation-resistant graphite. Preferably, the conductive carbon particles comprise from 10 to 100 percent by weight, for example between about 10 and 90 percent by weight oxidation-resistant graphite. Graphitized carbon can include graphitic carbon nanofibers alone or in an admixture with natural, synthetic or expanded graphite. Such mixtures are intended to be illustrative and are not intended to restrict the invention.

A preferred graphite for use as a conductive additive in cathodes comprising nickel oxyhydroxide is an oxidation-resistant graphite as reported in commonly assigned patent application publication US 2004-0197656 A1. Suitable oxidation-resistant synthetic graphites are available commercially under the trade designation “TIMREX SFG” from Timcal America Co. (Westlake, Ohio). SFG-type graphites suitable for use in an admixture with nickel oxyhydroxide in the cathode of the cell of the invention include SFG44, SFG15, SFG10, and SFG6 graphites. Particularly preferred oxidation resistant synthetic graphites include TIMREX® SFG10 and SFG15 graphites.

Anode 14 comprises zinc alloy powder between about 60 wt % and 80 wt %, between 62 wt % and 75 wt %, preferably between about 62 and 72 wt % of zinc particles. Preferably the zinc alloy powder comprises between about 62 to 72 wt % (99.9 wt % zinc containing indium containing 200 to 500 ppm indium as alloy and plated material), an aqueous KOH solution comprising 35.4 wt % KOH and about 2 wt % ZnO; a cross-linked acrylic acid polymer gelling agent available commercially under the tradename “CARBOPOL C940” from B.F. Goodrich (e.g., 0.5 to 2 wt %) and a gelling agent which is hydrolyzed polyacrylonitrile grafted onto a starch backbone commercially available under the tradename “Waterlock A-221” from Grain Processing Co. (between 0.01 and 0.5 wt. %); organic phosphate ester surfactant RA-600 or dionyl phenol phosphate ester surfactant available under the tradename RM-510 from Rhone-Poulenc (between 100 and 1000 ppm). The term zinc as used herein shall be understood to include zinc alloy powder which comprises a very high concentration of zinc, for example, at least 99.9 percent by weight zinc. Such zinc alloy material functions electrochemically essentially as pure zinc. The zinc particles in anode 14 may be any zinc particles conventionally used in alkaline cell zinc anodes. The zinc powder mean average particle size is desirably between about 1 and 350 micron, desirably between about 1 and 250 micron, preferably between about 20 and 250 micron.

### EXAMPLES

The performance zinc/nickel oxyhydroxide alkaline cells (Zn/NiOOH) cells 10 were tested to determine the effect of adding Laponite clay to the cathode. The first set of tests were made using AAA size cells (9 mm×44 mm) and the second set of tests were made using AA size cells (13.7 mm×47.3 mm). The cells were cylindrical cells having the general configuration as shown in the FIGURE. In each set (AAA and AA cells) a control alkaline cell was built with anode 14 comprising zinc and cathode 12 comprising nickel oxyhydroxide but without any Laponite clay additive to the cathode. Then the same cell with essentially the same anode and cathode compositions were built, but with Laponite clay added to the nickel oxyhydroxide cathode. The cathode and anode compositions for the AAA size cells are presented in Tables 1 and 2, respectively; and the cathode and anode compositions for the AA size cells are presented in Table 3 and 4, respectively.

The cathode 12 composition for the AAA size control and experimental cells (Table 1) comprised nickel oxyhydroxide, graphite, polyethylene binder, and alkaline electrolyte. The cathode compositions were essentially the same except that the experimental cell cathode (Formula B) contained 0.35 wt % of a 4% Laponite clay aqueous solution (pure Laponite clay was 0.04×0.35=0.014 wt % of the cathode mixture) whereas the control cell cathode (Formula A) contained the same amount (0.35 wt %) of added de-ionized water in place of the Laponite clay aqueous solution. As may be seen from Table 2, the same anode 14 composition (Formulation C) comprising zinc particles, alkaline electrolyte, gelling agents, and surfactant was used in both the control cell and experimental AAA size cells. The anode 14 and cathode 12 compositions may be prepared by mixing the components therein in a conventional blender operating at ambient temperature.

A set of Group I cells were tested. The Group I cells were AAA size cells with the control cells having a cathode Formulation A (Table 1) and anode Formulation C (Table 2). The experimental test cells had a cathode Formulation B (Table 1) and anode Formulation C (Table 2).

Similarly the cathode compositions for the AA size control and experimental cells (Table 3) were essentially the same except that one experimental cell cathode (Formula E) comprised 0.35 wt % of a 5% aqueous Laponite clay solution (pure Laponite clay was 0.05×0.35=0.0175 wt % of the cathode mixture) and a second experimental cell cathode (Formula F) comprised double the amount of Laponite clay, namely 0.70 wt % of a 5% aqueous Laponite clay solution (pure Laponite clay was 0.05×0.70=0.035 wt % of the cathode mixture). The control cell cathode (Formula D) contained de-ionized water in place of the Laponite clay. As may be seen from Table 4, the same anode composition (Formulation G) comprising zinc particles, alkaline electrolyte, gelling agents, and surfactant was used in both the control cell and experimental AA size cells.

A set of Group II cells were tested. The Group II cells were AA size cells with the control cells having a cathode Formulation D (Table 3) and anode Formulation G (Table 4). The experimental test cells had a cathode Formulation E (Table 3) and anode Formulation G (Table 4).

A set of Group III cells were tested. The Group III cells were AA size cells with the control cells having a cathode Formulation D (Table 3) and anode Formulation G (Table 4). The experimental test cells had a cathode Formulation F (Table 3) and anode Formulation G (Table 4).

### Group I—AAA Size Zn/NiOOH Control and Test Cells

(Test Cell cathodes Contained 0.014% Pure Laponite)

The capacities in the anode and cathode of this group of AAA cells (test cells contained 0.014 wt % pure Laponite) were balanced such that the theoretical capacity of the NiOOH (based on 292 mAmp-hr per gram NiOOH) divided by the theoretical capacity of the zinc (based on 820 mAmp-hr per gram zinc) was about 0.861. The cathode contained about 3.5 grams of NiOOH (pure basis).

### Group II—AA Size Zn/NiOOH Control and Test Cells

(Test Cell cathodes Contained 0.017% Pure Laponite)

The capacities in the anode and cathode of this group of AA cells (test cells contained 0.017 wt % Laponite) were balanced such that the theoretical capacity of the NiOOH (based on 292 mAmp-hr per gram NiOOH) divided by the theoretical capacity of the zinc (based on 820 mAmp-hr per gram zinc) was about 0.701. The cathode contained about 8.3 grams of NiOOH (pure basis).

### Group III—AA Size Zn/NiOOH Control and Test Cells

(Test Cell Cathodes Contained 0.035% Pure Laponite)

The capacities in the anode and cathode of this group of AA cells (test cells contained 0.035 wt % Laponite) were balanced such that the theoretical capacity of the NiOOH (based on 292 mAmp-hr per gram NiOOH) divided by the theoretical capacity of the zinc (based on 820 mAmp-hr per gram zinc) was about 0.698. The cathode contained about 8.3 grams of NiOOH (pure basis).

TABLE 1
Cathode Formulations
For AAA size Cell

| | | Formula-B |
|---|---|---|
| Cathode | Formula-A | Experimental |
| Component | Control (wt %) | (wt %) |
| NiOOH¹ | 84.65 | 84.65 |
| Clay (Laponite)² | 0.0 | 0.35 |
| (4% Laponite Soln.) | | |
| De-ionized Water | 0.35 | 0.0 |
| Graphite³ | 8.0 | 8.0 |
| Polyethylene | 1.0 | 1.0 |
| binder⁴ | | |
| Electrolyte | 6.0 | 6.0 |
| solution⁵ | | |
| Total | 100.0 | 100.0 |

Notes:
¹The NiOOH powder was comprised primarily of spherical beta-nickel(+3) oxyhydroxide having a mean average particle size (D50) of 12 microns. The NiOOH particles contained approximately 1.5 wt % cobalt, 3.0 wt % zinc, and 0.4 wt % potassium. The NiOOH particles had a BET surface area of 16.2 m²/g.
²The clay was the ionically conductive clay LAPONITE RD clay from Rockwood Inc. The typical LAPONITE crystal may contain 30000–40000 unit cells. The Laponite clay was added to the cathode mixture in the form of a dispersed aqueous mixture consisting of 4 percent by weight LAPONITE clay in water. Thus the actual amount of pure LAPONITE clay dispersed in the experimental Formula B cathode mixture is 0.04 × 0.35 = 0.014 percent by weight. The LAPONITE clay has theempirical formula: Na^{+0.7}_{0.70}[(Si₈Mg_{5.5}Li_{0.3})O₂₀(OH)₄]^{-0.7} as reported by Rockwood Inc.
³The graphite used was an oxidation resistant graphite available under the designation Timrex ® SFG15, which is a synthetic oxidation-resistant graphite having an average particle size of about 9 microns, a BET surface area of about 9.5 m²/g, a crystallite size, Lc >100 nm, and is available from Timcal-America (Westlake, OH).
⁴Polyethylene binder under the trade designation “Coathylene” from Hoechst Celanese.
⁵The electrolyte solution contains 35.4% by weight of dissolved potassium hydroxide (KOH) in water.

TABLE 2
Anode Formulation For Control and Experimetnal AAA Size Cells

| | Formulation |
|---|---|
| Anode Component | C (wt %) |
| Large Particle Zinc¹ | 19.20 |
| (−20/+200 mesh) | |
| Zinc fines²(−325 | 44.80 |
| mesh) | |
| Gelling agent 1³ | 0.522 |
| Gelling agent 2⁴ | 0.036 |
| Surfactant⁵ | 0.080 |
| Gassing inhibitor⁶ | 0.098 |
| Electrolyte⁷ | 35.264 |
| Total | 100.0 |

Notes:
¹Zinc-based particles having a mean average particle size of about 370 microns and were alloyed and plated with indium to give a total indium content of about 350 ppm. The −20/+200 mesh indicates that the zinc particles in this group have a particle size so that they pass through a Taylor screen of 20 mesh size square openings (0.850 mm) but do not pass through a Taylor screen of 200 mesh size square openings (0.075 mm).
²Zinc-based particles having a mean average particle size of about 35 microns and were alloyed and plated with indium to give a total indium content of about 700 ppm. The zinc particles in this group have a particle size small enough that they pass through a Taylor screen of 325 size square openings (0.045 mm).
³A polyacrylic acid-based gelling agent (crosslinked polyacrylic acid polymer) available under the tradename Carbopol 940 gelling agent from B.F. Goodrich Co.
⁴A grafted starch-based gelling agent (starch graft copolymer for example in the form of hydrolyzed polyacrylonitrile grafted unto a starch back boned) available under the tradename Waterlock A221 gelling agent from Grain Processing Corp.
⁵An organic phosphate ester-based surfactant available in the form of a 3 wt % solution under the trade designation RM 510 surfactant solution from Rhône Poulenc.
⁶Indium trichloride added as an inorganic gassing inhibitor.
⁷The electrolyte solution contained 35.4 percent by weight of dissolved KOH in water and about 2 percent by weight of dissolved zinc oxide in the total electrolyte.

TABLE 3
Cathode Formulations
For AA size Cell

| | Formula-D | Formula-E | Formala-F |
|---|---|---|---|
| | Control (wt | Experimental | Experimental |
| Cathode Component | %) | (wt %) | (wt %) |
| NiOOH¹ | 84.30 | 84.65 | 84.30 |
| Clay (Laponite)² | 0.0 | 0.35 | 0.70 |
| (5% Laponite | | | |
| Soln.) | | | |
| De-ionized Water | 0.70 | 0.0 | 0.0 |
| Graphite³ | 8.0 | 8.0 | 8.0 |
| Polyethylene | 1.0 | 1.0 | 1.0 |
| binder⁴ | | | |
| Electrolyte | 6.0 | 6.0 | 6.0 |
| solution⁵ | | | |
| Total | 100.0 | 100.0 | 100.0 |

Notes:
¹The NiOOH powder was comprised primarily of spherical beta-nickel(+3) oxyhydroxide having a mean average particle size (D50) of 12 microns. The NiOOH particles contained approximately 1.5 wt % cobalt, 3.0 wt % zinc, and 0.4 wt % potassium. The NiOOH particles had a BET surface area of 16.2 m²/g.
²The clay was the ionically conductive clay LAPONITE RD clay from Rockwood Inc. The typical LAPONITE crystal may contain 30000–40000 unit cells. The Laponite clay was added to the cathode mixture in the form of a dispersed aqueous mixture consisting of 5 percent by weight LAPONITE clay in water. Thus, the actual amount of pure LAPONITE clay dispersed in the experimental Formula E cathode mixture is 0.05 × 0.35 = 0.0175 percent by weight and the amount of pure LAPONITEclay in the experimental Formula F cathode mixture is 0.05 × 0.70 = 0.035 percent by weight. The LAPONITE clay has the empirical formula: Na^{+0.7}_{0.70}[(Si₈Mg_{5.5}Li_{0.3})O₂₀(OH)₄]^{-0.7} as reported by Rockwood Inc.
³The graphite used was an oxidation resistant graphite available under the designation Timrex ® SFG15, which is a synthetic oxidation-resistant graphite having an average particle size of about 9 microns, a BET surface area of about 9.5 m²/g, a crystallite size, Lc >100 nm, and is available from Timcal-America (Westlake, OH).
⁴Polyethylene binder under the trade designation “Coathylene” from Hoechst Celanese.
⁵The electrolyte solution contains 35.4 percent by weight of dissolved potassium hydroxide (KOH) in water.

TABLE 4
Anode Formulation For Control and Experimental AA Size Cells

| | Formulation- |
|---|---|
| Anode Component | G (wt %) |
| Large Particle Zinc¹ | 19.20 |
| (−20/+200 mesh) | |
| Zinc fines²(−325 | 44.80 |
| mesh) | |
| Gelling agent 1³ | 0.522 |
| Gelling agent 2⁴ | 0.036 |
| Surfactant⁵ | 0.080 |
| Gassing inhibitor⁶ | 0.074 |
| Electrolyte⁷ | 35.288 |
| Total | 100.0 |

Notes:
¹Zinc-based particles having a mean average particle size of about 370 microns and were alloyed and plated with indium to give a total indium content of about 350 ppm. The −20/+200 mesh indicates that the zinc particles in this group have a particle size so that they pass through a Taylor screen of 20 mesh size square openings (0.850 mm) but do not pass through a Taylor screen of 200 mesh size square openings (0.075 mm)
²Zinc-based particles having a mean average particle size of about 35 microns and were alloyed and plated with indium to give a total indium content of about 700 ppm. The zinc particles in this group have a particle size small enough that they pass through a Taylor screen of 325 size square openings (0.045 mm).
³A polyacrylic acid-based gelling agent (crosslinked polyacrylic acid polymer) available under the tradename Carbopol 940 gelling agent from B.F. Goodrich Co.
⁴A grafted starch-based gelling agent (starch graft copolymer for example in the form of hydrolyzed polyacrylonitrile grafted unto a starch back boned) available under the tradename Waterlock A221 gelling agent from Grain Processing Corp.
⁵An organic phosphate ester-based surfactant available in the form of a 3 wt % solution under the trade designation RM 510 surfactant solution from Rhône Poulenc.
⁶Indium trichloride added as an inorganic gassing inhibitor.
⁷The electrolyte solution contained 35.4 percent by weight of dissolved KOH in water and about 2 percent by weight of dissolved zinc oxide in the total electrolyte.

### Performance Tests

The above described Group I of AAA size cells and Groups II and III of AA size cells were then subjected to various performance tests to simulate the normal usage of such cells in digital cameras and the like and after storage.

Since the zinc/nickel oxyhydroxide cell may lose some of its capacity when the fresh cells are stored before use, the control cells and test experimental cells were subjected to accelerated storage conditions first before testing, but the cells were also tested fresh as well.

### Group I—Performance Test Results

AAA Size Zinc/NiOOH Control and Test Cells

(Test Cells Contained 0.014 wt % Pure Laponite in Cathode)

Test cells and control cells having the zinc anode and NiOOH cathode compositions above described for the Group I cells (test cell cathodes contained 0.014 wt % pure Laponite clay) were tested. A first subgroup of test cells and control cells were tested as fresh cells. A second subgroup of test cells and control cells were stored 1 week at 60° C. before discharge at room temperature. A third subgroup of test cells and control cells were stored 2 weeks at 60° C. before discharge at room temperature. These cells were all discharged to simulate a “digital camera” test regime as follows: Discharge at 900 mWatt for 2 seconds followed immediately by 390 mWatt for 30 seconds; this cycle repeated for 5 minutes followed by a 55 minute rest period and the entire cycle repeated until cell voltage decreased to a cut off voltage of 1.05 volt.

The cells from the first subgroup (cells discharged fresh) had a total pulse count of 251 pulses compared to 250 pulses for the control cell. The cells from the second subgroup (cells discharged after 1 week storage at 60° C.) had a total pulse count of 207 pulses compared to 200 pulses for the control cell. The cells from the third subgroup (cells discharged after 2 week storage at 60° C.) had a total pulse count of 191 pulses compared to 177 pulses for the control cell.

The test zinc/NiOOH cells (containing 0.014 wt % pure Laponite clay in the cathode) showed about the same capacity as the control cells when the cells were tested as fresh cells. However, the test cells clearly showed greater capacity than the control zinc/NiOOH cells (without any clay additive in cathode) when the cells were subjected to storage conditions 1 week at 60° C. or 2 weeks at 60° C. before testing.

The test cells and control cells were subjected to two other tests, one to simulate use in a CD/MP3 player and the other an ANSI/IEC Remote test. Before subjecting the test and control cells to these test regimes, the cells were first subjected to the following daily (24 hour) accelerated storage simulation sequence for 14 days as follows: Ramp temperature gradually from 28 to 25° C. (6 hour time period); ramp temperature from 25 to 34° C. (4.5 hours); ramp temperature from 34 to 43° C. (2.0 hours); ramp temperature from 43 to 48° C. (1.0 hour); ramp temperature from 48 to 55° C. (1.0 hour); ramp temperature from 55 to 48° C. (1.0 hour); ramp temperature from 48 to 43° C. (1.0 hour); ramp temperature from 43 to 32° C. (3.0 hour); and ramp temperature from 32 to 28° C. (4.5 hour).

After being subjected to this accelerated storage regimen the test and control cells were subjected to a CD/MP3 test. The test protocol was as follows: 50 mWatt discharge for 40 seconds followed immediately by 225 mWatt for 30 seconds; this cycle repeated for 52 times followed by a 3 hour rest period and the entire cycle repeated until cell voltage decreased to 0.8 voltage. The total service hours for the test cells was 7.71 compared to 7.6 hours for the control cells.

In another test, after being subjected to the above accelerated storage regimen, the test cells and control cells were subjected to an ANSI/IEC Remote test. The test protocol was as follows: 24 ohm discharge for 15 seconds per minute for 8 hours per day to a cut off voltage of 1.0 volt. The total service hours for the test cells were 10.2 compared to 9.4 service hours for the control cells.

### Group II—Performance Test Results

AA Size Zinc/NiOOH Control and Test Cells

(Test Cells Contained 0.017 wt % Pure Laponite in Cathode)

Test cells and control cells having the zinc anode and NiOOH cathode compositions above described for the Group II cells (test cell cathodes contained 0.017 wt % pure Laponite clay) were tested. A first subgroup of test cells and control cells were tested as fresh cells. A second subgroup of test cells and control cells were stored 1 week at 60° C. before discharge at room temperature. A third subgroup of test cells and control cells were stored 2 weeks at 60° C. before discharge at room temperature. These cells were all discharged to simulate a “digital camera” test regime using the ANSI (American National Standards Institute) Digital Camera Test protocol as follows: Discharge at 1500 mWatt for 2 seconds followed immediately by 650 mWatt for 28 seconds; this cycle repeated for 5 minutes followed by a 55 minute rest period and the entire cycle repeated until cell voltage decreased to a cut off voltage of 1.05 volt.

The cells from the first subgroup (cells discharged fresh) had a total pulse count of 286 pulses compared to 266 pulses for the control cell. The cells from the second subgroup (cells discharged after 1 week storage at 60° C.) had a total pulse count of 237 pulses compared to 207 pulses for the control cell. The cells from the third subgroup (cells discharged after 2 week storage at 60° C.) had a total pulse count of 212 pulses compared to 204 pulses for the control cell.

The test zinc/NiOOH cells (containing 0.017 wt % pure Laponite clay in the cathode), clearly showed greater capacity than the control zinc/NiOOH cells (without any clay additive in cathode) when the cells were subjected to testing as fresh cells as well as when subjected to storage conditions 1 week at 60° C. or 2 weeks at 60° C. before testing.

After being subjected to the accelerated storage regimen (See Group I, for the accelerated storage regimen) the test and control cells were subjected to an ANSI/IEC photo flash test. The test protocol was as follows: 1 Amp discharge for 10 seconds per minute for 1 hour per day to a cut off voltage of 0.9 volt. The total pulse count for the test cells was 489 compared to 476 pulses for the control cell.

In another test, after being subjected to the accelerated storage regimen (See Group I, for the accelerated storage regimen), the test cells and control cells were subjected to an ANSI/IEC Remote test. The test protocol was as follows: 24 ohm discharge for 15 seconds per minute for 8 hours per day to a cut off voltage of 1.0 volt. The total service hours for the test cells were 24.9 compared to 24.6 service hours for the control cells.

### Group III—Performance Test Results

AA Size Zinc/NiOOH Control and Test Cells

(Test Cells Contained 0.035 wt % Pure Laponite in Cathode)

Test cells and control cells having the zinc anode and NiOOH cathode compositions above described for the Group III cells (test cell cathodes contained 0.035 wt % pure Laponite clay) were tested. A first subgroup of test cells and control cells were tested as fresh cells. A second subgroup of test cells and control cells were stored 1 week at 60° C. before discharge at room temperature. A third subgroup of test cells and control cells were stored 2 weeks at 60° C. before discharge at room temperature. These cells were all discharged to simulate a “digital camera” test regime using the ANSI (American National Standards Institute) Digital Camera Test protocol as follows: Discharge at 1500 mWatt for 2 seconds followed immediately by 650 mWatt for 28 seconds; this cycle repeated for 5 minutes followed by a 55 minute rest period and the entire cycle repeated until cell voltage decreased to a cut off voltage of 1.05 volt.

The cells from the first subgroup (cells discharged fresh) had a total pulse count of 271 pulses compared to 266 pulses for the control cell. The cells from the second subgroup (cells discharged after 1 week storage at 60° C.) had a total pulse count of 207 pulses compared to 207 pulses for the control cell. The cells from the third subgroup (cells discharged after 2 week storage at 60° C.) had a total pulse count of 201 pulses compared to 204 pulses for the control cell.

The test zinc/NiOOH cells (containing 0.035 wt % pure Laponite clay in the cathode), did not show any capacity improvement over the control zinc/NiOOH cells (without any clay additive in cathode) as the number of pulses for the test cells and control cells were about the same for the simulated digital cameral test. The test cells did not show an improvement when the cells were first subjected to accelerated storage conditions, but the test cells did show an improvement when the cells were tested fresh.

After being subjected to the accelerated storage regimen (See Group I, for the accelerated storage regimen) the test and control cells were subjected to an ANSI/IEC photo flash test. The test protocol was as follows: 1 Amp discharge for 10 seconds per minute for 1 hour per day to a cut off voltage of 0.9 volt. The total pulse count for the test cells was 493 compared to 473 pulses for the control cell.

In another test, after being subjected to the accelerated storage regimen (See Group I, for the accelerated storage regimen), the test cells and control cells were subjected to an ANSI/IEC Remote test. The test protocol was as follows: 24 ohm discharge for 15 seconds per minute for 8 hours per day to a cut off voltage of 1.0 volt. The total service hours for the test cells were 25.1 compared to 24.6 service hours for the control cells.

The performance tests as a whole indicate that there is an overall significant performance benefit resulting from adding small amounts of ionically conductive clay, such as LAPONITE clay, to cathodes comprising nickel oxyhydroxide in a zinc/nickel oxyhydroxide alkaline cell.

Although the invention was described with respect to various specific embodiments, it will be appreciated that other embodiments are possible and within the concept of the invention. Thus, the invention is not intended to be limited to the specific embodiments herein and is reflected by the scope of the claims.

What is claimed is:

1. A primary alkaline cell comprising a negative and a positive terminal and an outer housing; said cell further comprising an anode and cathode within said housing; said anode comprising zinc particles; and said cathode comprising nickel oxyhydroxide particles and an ionically conductive clay dispersed within said cathode; said cell further comprising a separator between said anode and cathode, and an alkaline electrolyte solution contacting said anode and cathode.

2. The cell of claim 1 wherein said clay comprises between about 0.01 and 0.4 percent by weight of said cathode and said clay is dispersed throughout said cathode.

3. The cell of claim 1 wherein said ionically conductive clay is selected from the group consisting of kaolins, pyrophyllites, smectites, hectorites, illites, glauconites, chlorites, and vermiculites, and mixtures thereof.

4. The cell of claim 1 wherein said ionically conductive clay comprises a hectorite.

5. The cell of claim 4 wherein said hectorite is a synthetic hectorite having the empirical formula Na^{+7.0}_{0.70}[(Si₈Mg_{5.5}Li_{0.3})O₂₀(OH)₄]^{0.7}.

6. The alkaline cell of claim 1 wherein said zinc in the anode is in the form of a powder having a mean average particle size between about 1 and 250 micron.

7. The alkaline cell of claim 1 wherein said zinc in the anode is in the form of a powder having a mean average particle size between about 20 and 250 micron.

8. The alkaline cell of claim 1 wherein said cathode comprises nickel oxyhydroxide particles, an ionically conductive clay, and a conductive carbon.

9. The alkaline cell of claim 8 wherein said cathode further comprises manganese dioxide particles in admixture with said nickel oxyhydroxide particles, ionically conductive clay and conductive carbon.

10. The alkaline cell of claim 8 wherein said conductive carbon comprises graphite.

11. The alkaline cell of claim 1 wherein said electrolyte solution comprises aqueous potassium hydroxide.

12. The alkaline cell of claim 1 wherein said nickel oxyhydroxide particles have a mean average particle size between about 2 to 50 microns.

13. The alkaline cell of claim 1 wherein said nickel oxyhydroxide particles have a mean average particle size between about 5 to 30 microns.

14. The alkaline cell of claim 1 wherein said ionically conductive clay in said cathode improves cell performance.

15. A primary alkaline cell comprising a negative and a positive terminal, and an outer housing having a closed end and opposing open end; said cell further comprising an anode and cathode within said housing; said anode comprising zinc particles; and said cathode comprising nickel oxyhydroxide particles and an ionically conductive clay dispersed within said cathode; said clay is selected from the group consisting of kaolins, pyrophyllites, smectites, hectorites, illites, glauconites, chlorites, and vermiculites, and mixtures thereof; said cell further comprising a separator between said anode and cathode, an alkaline electrolyte solution contacting said anode and cathode, and an end cap assembly sealing the open end of said housing.

16. The cell of claim 15 wherein said clay comprises between about 0.01 and 0.4 percent by weight of said cathode.

17. The alkaline cell of claim 15 wherein said zinc in the anode is in the form of a powder having a mean average particle size between about 1 and 250 micron.

18. The alkaline cell of claim 15 wherein said zinc in the anode is in the form of a powder having a mean average particle size between about 20 and 250 micron.

19. The alkaline cell of claim 15 wherein said cathode comprises nickel oxyhydroxide particles, an ionically conductive clay, and a conductive carbon.

20. The alkaline cell of claim 19 wherein said cathode further comprises manganese dioxide particles in admixture with said nickel oxyhydroxide particles, said ionically conductive clay, and conductive carbon.

21. The alkaline cell of claim 19 wherein said conductive carbon comprises graphite particles.

22. The alkaline cell of claim 15 wherein said electrolyte solution comprises aqueous potassium hydroxide.

23. The alkaline cell of claim 15 wherein said nickel oxyhydroxide particles have a mean average particle size between about 2 to 50 microns.

24. The alkaline cell of claim 15 wherein said nickel oxyhydroxide particles have a mean average particle size between about 5 to 30 microns.

25. The alkaline cell of claim 15 wherein said ionically conductive clay in said cathode improves cell performance.

26. A primary alkaline cell comprising a negative and a positive terminal, and an outer housing having a closed end and opposing open end; said cell further comprising an anode and cathode within said housing; said anode comprising zinc particles; and said cathode comprising nickel oxyhydroxide particles and an ionically conductive clay comprising a hectorite clay dispersed within said cathode; said cell further comprising a separator between said anode and cathode, an alkaline electrolyte solution contacting said anode and cathode, and an end cap assembly sealing the open end of said housing.

27. The cell of claim 26 wherein said clay comprises between about 0.01 and 0.4 percent by weight of said cathode.

28. The cell of claim 26 wherein said ionically conductive clay comprises a synthetic hectorite.

29. The cell of claim 28 wherein said hectorite is a synthetic hectorite having the empirical formula Na^{+0.7}_{0.70}[(Si₈Mg_{5.5}Li_{0.3})O₂₀(OH)₄]^{-0.7}.

30. The alkaline cell of claim 26 wherein said zinc in the anode is in the form of a powder having a mean average particle size between about 1 and 250 micron.

31. The alkaline cell of claim 26 wherein said zinc in the anode is in the form of a powder having a mean average particle size between about 20 and 250 micron.

32. The alkaline cell of claim 26 wherein said cathode comprises nickel oxyhydroxide particles, an ionically conductive clay, and a conductive carbon.

33. The alkaline cell of claim 32 wherein said cathode further comprises manganese dioxide particles in admixture with said nickel oxyhydroxide particles, said ionically conductive clay and conductive carbon.

34. The alkaline cell of claim 32 wherein said conductive carbon comprises graphite particles.

35. The alkaline cell of claim 26 wherein said electrolyte solution comprises aqueous potassium hydroxide.

36. The alkaline cell of claim 26 wherein said nickel oxyhydroxide particles have a mean average particle size between about 2 to 50 microns.

37. The alkaline cell of claim 26 wherein said nickel oxyhydroxide particles have a mean average particle size between about 5 to 30 microns.

38. The alkaline cell of claim 26 wherein said ionically conductive clay in said cathode improves cell performance.
